(19) United States
(12) Patent Application Publication
(10) Pub. No.: US 2011/0170316 A1
(43) Pub. Date: Jul. 14, 2011

(54) LIGHT GUIDE

(75) Inventor: Theodorus Franciscus Emilius Maria Overes, Eindhoven (NL)

(73) Assignee: KONINKLIJKE PHILIPS ELECTRONICS N.V., EINDHOVEN (AE)

(21) Appl. No.: 13/119,230

(22) PCT Filed: Sep. 17, 2009
(86) PCT No.: PCT/IB2009/054072

§ 371 Date: Mar. 16, 2011

(30) Foreign Application Priority Data
Sep. 23, 2008 (EP) 08164916.2

(51) Int. Cl. F21V 8/00; G02B 6/10

(52) U.S. Cl. 362/615; 264/1.24

(57) ABSTRACT

This invention relates to a light guide (100). A first light guide portion (101) extending at least partly along the light guide is provided from conducting an incoming light along the first light guide portion. A second light guide portion (102) having a light out coupling structure is provided for coupling out an incoming light from the first light guide portion. The first and the second light guide portions are separated by a light separation structure (103), where the amount of light conducted from the first light guide portion towards the second light guide portion is determined by the thickness of the light separation structure.

### FIELD OF THE INVENTION

The present invention relates to providing light guide that is capable of distributing an incoming light uniformly within the light guide.

### BACKGROUND OF THE INVENTION

In many applications, flat light guides offer the opportunity to have very “flat” light sources. These light guides are often combined with LED's, which do not contain mercury, are efficient, use low voltages, have long lifetime, and offer the opportunity to produce saturated colors. Applications are backlights of displays, and also direct view light panels e.g. in combination with Flat TV (Ambilight).

To realize a uniform brightness, the light of the concentrated light source like a LED must be able to spread out over the area of the light guide. In case multi color LED's are used, also appropriate color mixing is required. To reduce the dimension of the light guide, arrays of LED's are used which are positioned at a small pitch.

In case elongated light guides are required, it has to be decided from which side(s) the light will be coupled into the light guide. Using the long side(s) will result in a high number of LED's, and so increased cost. Using the short side(s) of the light guide will result in a lower number of LED's, but also in an uneven brightness over the length. The amount of coupled out light can be more or less controlled by adapting the size or concentration of the couple out features over the length, but this will have its limits. There will be a minimum size of coupling out feature, too large pitches will become visible, and there will be a difference in appearance when correcting brightness of the feature by size or concentration. Especially in the off-state, this last issue might cause a problem.

A solution to achieve a more even brightness and appearance is to couple out less light, but this will significantly affect efficiency and cost (in a negative way). The use of arrays of LED's requires good color uniformity at 0-hour, but also over lifetime. This is a difficult requirement taking into account LED binning and degradation issues. In general, more area and volume has to be reserved for mixing light of the used LED's, to avoid unacceptable color differences.

### SUMMARY OF THE INVENTION

The object of the invention is to provide light guide that is capable of distributing light uniformly within the light guide without requiring a large number of light sources.

According to one aspect the present invention relates to a light guide comprising:

at least one first light guide portion extending at least partly along the light guide and adapted for conducting an incoming light along the first light guide portion,

at least one second light guide portion comprising a light out coupling means for coupling out an incoming light from the at least one first light guide portion,

wherein the at least one first and the at least one second light guide portions are separated by at least one light separation structure, the amount of light conducted from the at least one first light guide portion towards the at least one second light guide portion being determined by the dimensions of the light separation structure.

Thus, the light separation structure may be implemented for spreading out the light over the length of the light guide. This results in a uniform light distribution without requiring a large number of light sources. Also, the amount of light coupled from the at least one first light guide portion towards the at least one second light guide portion may be controlled. The incoming light may be a light from two or more light sources, where the color of the light of these light sources can be chosen differently. In that way, colored patterns of the out coupled light can be achieved, including transition area's from one color to the other color(s).

In one embodiment, the light separation structure is created by a substantial U or V-shape groove formed into the light guide, the amount of light conducted from the at least one first light guide portion into the at least one second light guide portion being controlled by means of varying the depth of the groove and thus the thickness of the light separation structure.

Thus, the thickness of the light separation structure determines the amount of “leakage of light” from the at least one first light guide portion into the at least one second light guide portion. Accordingly, where the light intensity is highest, i.e. where the light enters the at least one first light guide portion, the thickness of the light separation structure would typically be lowest so as to reduce the amount of light entering at least one second light guide portion, and increase the thickness uniformly along the light guide. The result is that the light distribution within the at least one second light guide portion can be fully controlled.

In one embodiment, the controlling of the amount of light conducted from the at least one first light guide portion into the at least one second light guide portion is further based on varying the shape of the U or V-shape groove.

Thus, an additionally control parameter is provided to control the light leakage from the at least one first light guide portion into the at least one second light guide portion. It is namely so that walls under an angle will bend the reflected rays, and increase the chance that they enter the separation structure. For this reason the shape of the separation structure will influence the amount of leaking light from the at least one first light guide portion towards the at least one second light guide portion.

In one embodiment, the light separation structure is created by a substantial U or V-shape groove formed from both sides of the light guide, opposite to each other.

In one embodiment, the light separation structure has a steadily increasing thickness with the thickness at the end where the incoming light enters the first light guide portion as the lowest one, the increase of the thickness being used to stimulate the amount of light conducted between the at least on first light guide portion towards the at least one second light guide portion.

In that way, it is ensured that the amount of light that enters the at least one second light guide portion will be substantially constant along the light guide. It is however also possible to position the light sources, e.g. Light Emitting Diodes (LED's) at both sides of the first light guide portion, to increase the brightness and further increase the uniformity, or to allow longer light guides.

In one embodiment, the at least one first light guide portion forms a substantially straight line or a curve, or a combination of both.

The light can therefore be conducted along a string line, along a U shape line, along circle etc. The shape of the at least one first light guide portion can thus be adapted to the shape of the at least one second light guide portion, e.g. around a corner, or used to improve the light distribution further.

In one embodiment, the width of the at least one first light guide portion is significantly smaller with respect to the radius of the curves.

In that way the amount of light that is lost in these curves is reduced.

In one embodiment, the at least one first light guide portion has an opening-end at one end of the light guide where the incoming light enters the at least one first light guide portion at the opening-end and where the opposite end of the at least one first light guide portion is mirror coated, or has a mirror mounted on this opposite end.

Thus, the remaining light from the at least one first light guide portion that has not yet been coupled out to the at least one second light guide portion will be reflected at the opposite end resulting in an improved uniformity in the direction of the largest dimension, improved efficiency, higher brightness and/or allowing longer light guides.

In one embodiment, the at least second light guide portion is mirror coated or has a mirror mounted on one or more sides.

In that way, the efficiency and uniformity within this second light guide portion is improved.

In one embodiment, the at least one first light guide portions splits in two or more sub portions.

In this way the distribution of the light over the lightguide can be improved, and more complex shapes of the at least one second light guide portion will be possible.

In one embodiment, the lightguide contains two or more first lightguide portions, each being equipped with a light source.

In this way the distribution of the light over the lightguide can be improved and higher brightness can be achieved. Also, larger light guides can be created and more complex shapes of the at least one second light guide portion will be possible.

In one embodiment the two first light guide portions intersect.

This results in that the intensity and/or the color of the light guides will be mixed in these portions and thus the color and/or brightness uniformity can be improved, or certain transitions can be achieved regarding brightness or color.

In one embodiment, the light guide has a three-dimensional structure and where the at least one first light guide portion includes one or more first light guide portions extending within the three-dimensional structure.

This first light guide portion may also be adapted to pass light to the three or more second light guide portions.

According to another aspect, the present invention relates to a method of manufacturing said light guide, comprising:

notching into the light guide to create the light separation structure, or

molding the light guide with first light guide portion and the light separation structure integrated therein.

The aspects of the present invention may each be combined with any of the other aspects. These and other aspects of the invention will be apparent from and elucidated with reference to the embodiments described hereinafter.

### BRIEF DESCRIPTION OF THE DRAWINGS

Embodiments of the invention will be described, by way of example only, with reference to the drawings, in which

FIG. 1 shows a light guide according to the present invention comprising one first light guide portion and one second light guide portion,

FIG. 2 a)-e) shows examples of cross sections of a light guide according FIG. 1, and

FIG. 3 a)-d) depicts graphically how the shape of the light separation structure 103 varies along the light guide in FIG. 1.

### DESCRIPTION OF EMBODIMENTS

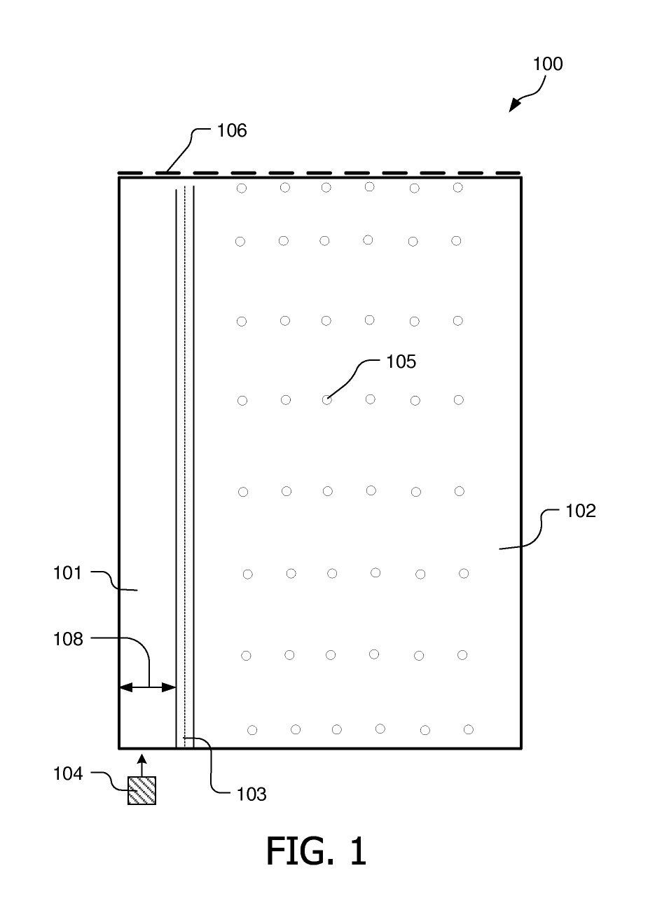

FIG. 1 shows a light guide 100 according to the present invention comprising one first light guide portion 101 and one second light guide portion 102. As depicted here, the first light guide portion 101 extends along the light guide 100 and a light source 104 is pointed up towards one end of the first light guide portion 101. The second light guide portion 102, which as shown here, is significantly larger than the first light guide portion 101 comprises a light out coupling means 105 for coupling out an incoming light from the at least one first light guide portion. The light out coupling means 105 may be made by e.g. by gluing tape on the surface of the light guide 100, or by painting or printing the surface of the light guide 100, or by sandblasting or adding texture uniformly onto the surface of the light guide, or by making indents into the surface, or by putting protrusions on the surface. Other well known technologies may also be used to provide such an out coupling means 105. The light guide 100 may be a flat or a bended plate (i.e. a substantial two dimensional light guide), or have a three dimensional structure, e.g. a “thick plate”, or a cube, i.e. where the thickness of the light guide is not negligible compared to the length of the sides.

The first and the second light guide portions are separated by a light separation structure 103. The purpose of the light separation structure 103 is to form an adjustable “light barrier” between the first and the second light guide portions such that the amount of light conducted from the first light guide portion 101 towards the second light guide portion 102 may be controlled. This “light barrier” is adjustable by adjusting the dimension of the light separation structure 103.

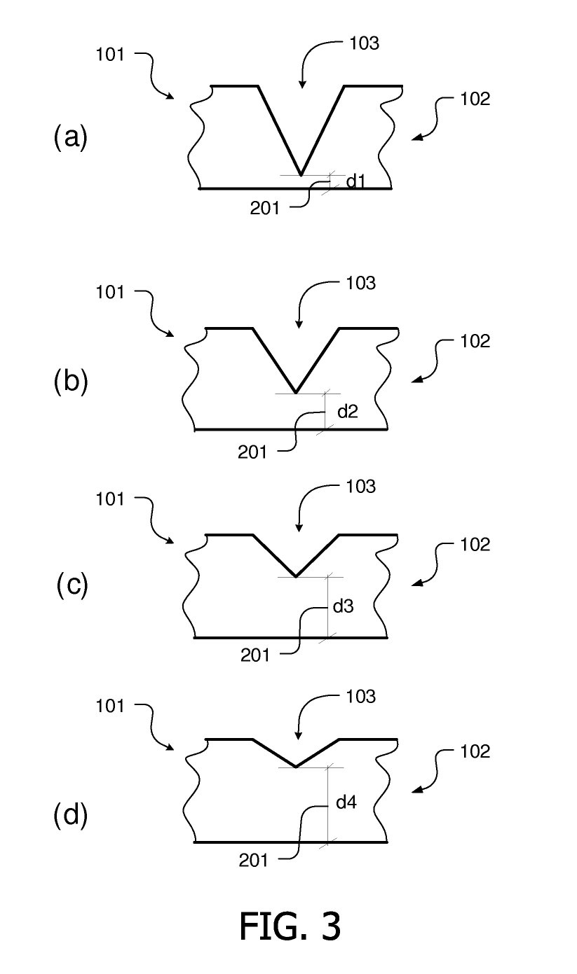

In one embodiment, the dimension comprises the thickness of the light separation structure 103 (see FIG. 3) such that amount of light being conducted depends on the thickness of the light separation structure 103 such that the more thicker the light separation structure 103 is the more light will be conducted from the first light guide portions 101 towards the second light guide portion 102.

In that way, by adjusting the thickness of the light separation structure 103 an adjustable/controllable “light barrier” is created which determines the relative amount of light to be conducted from the first light guide portion 101 towards the second light guide portion 102. The term dimension can also be the various cross sectional shapes and/or width (and/or the depth) of the light separation structure 103.

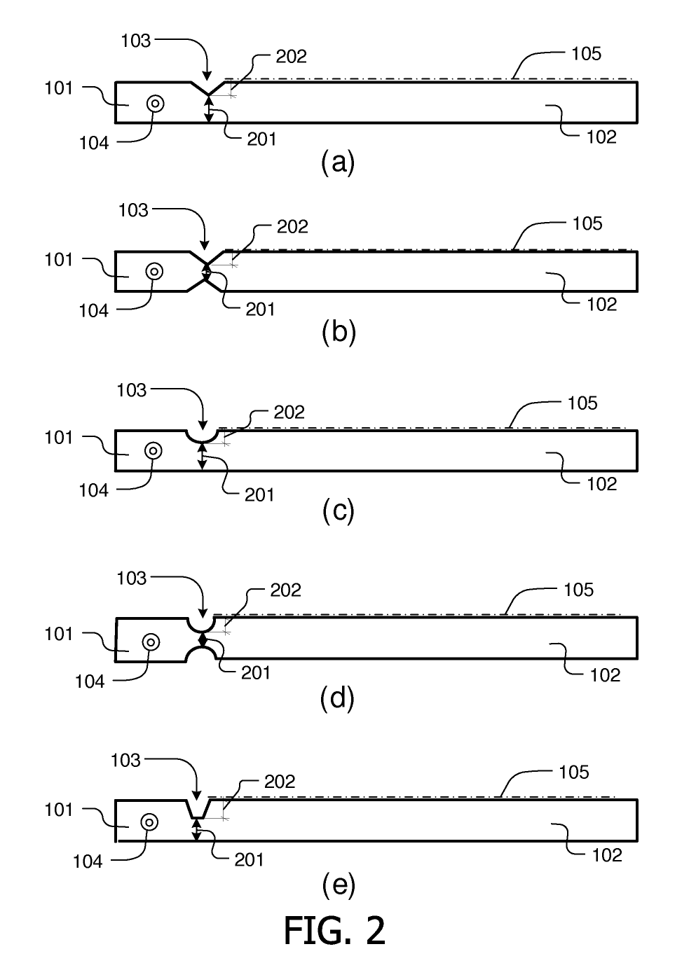

In one embodiment, the light separation structure 103 is created by a substantial U or V-shape groove (see FIG. 2) formed into the light guide, where the amount of light conducted from the at least one first light guide portion 101 into the at least one second light guide portion 102 is based on varying the shape of the light separation structure. As an example, the angle of the walls of the light separation structure will bend the reflected rays, and thus increase the chance that they enter the separation structure. For this reason the shape of the separation structure will influence the amount of leaking light from the at least one first light guide portion towards the at least one second light guide portion.

As depicted in FIG. 1, a light source 104, e.g. a Light Emitting Diode (LED), is pointed up and towards an opening-end first light guide portion 101. In one embodiment, the opposite end of the first light guide portion 101 and second light guide portion 102 is mirror coated 106 so that the remaining light within the first light guide portion 101 and the second light guide portion that is not coupled out will be reflected back towards the opening-end and thus will remain available for out-coupling.

The light guide 100 shown in this embodiment contains only one first light guide portion 101 and one second light guide portion 102, the number of light guide portions may easily be varied. As an example, the first light guide portion 101 could be situated in-between two second light guide portions 102 separated by two light separation structures 103. Another example is where two or more light guides as depicted here 100 are placed side by side.

Although the light guide 100 is shown as a rectangular light guide, it may of course have variable shape and size. Also, the first light guide portion 101 shown here forms a substantially straight line along the light guide. However, the first light guide portion 101 may have curved shape, e.g. curves of 90° or 180° (not shown), or a circle or a portion of a circle. In such cases, it is preferred that the width 108 of the at least one first light guide portion is significantly smaller with respect to the radius of the curves (circle).

One example of an implementation for such a frame structure is for monitors, displays, TV's and any types of screens, to form a light emitting frame structure, where even two or more first light guide portions 101 could (or would have to) be used. More specifically, this light guide could be implanted as a frame structure in conjunction with ambilight based TV's. This could event be used as an ergonomic light frame for e.g. a computer monitor to enhance the working conditions for computer users that maybe sit many hours a day in front of computers.

FIG. 2 a)-e) shows a cross section of a light guide (e.g. light guide 100 from FIG. 1), showing various types cross sections of the light separation structure 103. Shown is also the light source 104, the first and the second light guide portions 101, 102 and the light out coupling means 105.

In FIG. 2 a)-e) the light separation structure 103 is created by a substantial U- or V-shape groove formed into the light guide, where the light leakage from the first light guide portion 101 into second light guide portion 102 may be controlled by means of varying the depth 202 of the groove and thus the thickness of the light separation structure 201 such that the larger the thickness 201 becomes the larger will the amount of light leakage be from the first light guide portion 101 into the second light guide portion 102. In FIG. 2 a) the substantially U-shape structure is formed from only one side of the light separation structure 103. FIG. 2 b) and e) shows where the substantial U and V-shape groove are realized from both sides of the plate opposite to each other. Although these cross sections are symmetrical, they may just as well be asymmetrical.

An example of light guides as depicted in FIGS. 1 and 2 are light guides made from highly transparent material like an optical grade of PMMA, and which are shaped as a flat plate with thickness 201 between e.g. 1 and 5 mm. In one embodiment, the first light guide portion 101 has a width identical to the thickness of the plate, but the width may also be adapted to the width of the used LED. The width of the second light guide portion 102 may be adapted to the required size of the lighted area. The cross section is constant from the end where the light enters up to the opposite end, except that the light separation structure gradually changes to control the light leakage from the first light guide portion to the second light guide portion. Because of this constant cross-section, combined with a polished surface of the light guide, the light will be guided as result of total internal reflection from the entering side to the opposite side, without significant loss.

The out coupling can be foreseen by painting the backside of the second light guide portion with a diffuse reflective paint, disturbing the total internal reflection, and causing out coupling at the opposite side of the second light guide portion. In the off-state (no light added by the light source), the surface will have a homogenous appearance.

FIG. 3 depicts graphically a scenario showing how the thickness 201 of the light separation structure 103 varies along the light guide 100 in FIG. 1, where FIG. 1a) could be the opening-end where the light enters the light guide 100 and FIG. 1d) the opposite end (up-most end in FIG. 1). In this example, it is assumed that the light separation structure 103 is V-shaped and has a constant width (from above). In FIG. 3 a) where the thickness 201 d₁ is lowest, the leakage of light from the first light guide portion 101 to the second light guide portion 102 should be lowest since the light intensity is highest, i.e. the light barrier must be largest at this end. To ensure a uniform light distribution within the second light guide portion 102, this thickness 201 must increase steadily with the thickness at the opposite end d₄ as the largest one. In that way, a controllable “light barrier” is created so that the “leakage” of light from the first light guide portion 101 to the second light guide portion 102 can be controlled such that the “leakage” becomes substantially constant along the light guide 100.

Additionally, as mentioned previously, the shape of the V-shape structure (or U-shape structure) could be used as an additional control parameter to adjust the leakage of light from the first light guide portion 101 towards the second light guide portion 102, e.g. by rotating the cross sectional V-shape (not shown here) such that angle between the light within the first light guide portion 101 and the wall of the V-shape changes, or by varying the width (see FIG. 1) of the light separation structure 103.

Although not shown here, the light guide may have a three-dimensional structure and where the integrated first light guide portion comprises at least one first light guide portion extending within the three-dimensional structure, or at the surface, or both.

Certain specific details of the disclosed embodiment are set forth for purposes of explanation rather than limitation, so as to provide a clear and thorough understanding of the present invention. However, it should be understood by those skilled in this art, that the present invention might be practiced in other embodiments that do not conform exactly to the details set forth herein, without departing significantly from the spirit and scope of this disclosure. Further, in this context, and for the purposes of brevity and clarity, detailed descriptions of well-known methodologies have been omitted so as to avoid unnecessary detail and possible confusion.

Reference signs are included in the claims, however the inclusion of the reference signs is only for clarity reasons and should not be construed as limiting the scope of the claims.

1. A light guide (100) comprising:
at least one first light guide portion (100) extending at least partly along the light guide (100) and adapted for conducting an incoming light along the first light guide portion (101),
at least one second light guide portion (102) comprising a light out coupling means (105) for coupling out an incoming light from the at least one first light guide portion (101),
wherein the at least one first (101) and the at least one second (102) light guide portions are separated by at least one light separation structure (103), the amount of light conducted from the at least one first light guide portion (101) towards the at least one second light guide portion (102) being determined by the dimensions of the light separation structure (103).

2. A light guide according to claim 1, wherein the light separation structure (103) is created by a substantial U or V-shape groove formed into the light guide, the amount of light conducted from the at least one first light guide (101) portion into the at least one second light guide portion (102) being controlled by means of varying the depth of the groove (202) and thus the thickness (201) of the light separation structure.

3. A light guide according to claim 2, wherein controlling of the amount of light conducted from the at least one first light guide portion (101) into the at least one second light guide portion (102) is further based on varying the shape of the U or V-shape groove.

4. A light guide according to claim 2, wherein the U or V-shape strip is realized from both sides of the light guide, opposite to each other.

5. A light guide according to claim 1, wherein the light separation structure (103) has a steadily increasing thickness with the thickness at the end where the incoming light enters the first light guide portion (101) as the lowest one, the increase of the thickness being used to stimulate the amount of light conducted between the at least on first light guide portion towards the at least one second light guide portion (102).

6. A light guide according to claim 1, wherein the at least one first light guide portion (101) forms a substantially straight line or a curve, or a combination of both.

7. A light guide according to claim 6, wherein the width (108) of the at least one first light guide portion (101) is significantly smaller with respect to the radius of the curves.

8. A light guide according to claim 1, wherein the at least one first light guide portion (101) has an opening-end at one end of the light guide where the incoming light enters the at least one first light guide portion at the opening-end and where the opposite end of the at least one first light guide portion (101) is mirror coated, or a mirror mounted on this opposite end.

9. A light guide according to claim 1, wherein the at least second light guide portion (102) is mirror coated or has a mirror mounted on one or more sides.

10. A light guide according to claim 1, wherein the at least one first light guide portion (101) splits in two or more sub portions.

11. A light guide according to claim 1, wherein the light guide contains two or more first light guide portions (101), each being equipped with a light source.

12. A light guide according to claim 11, wherein the two or more first light portions intersect.

13. A light guide according to claim 1, wherein the light guide (100) has a three-dimensional structure and where the at least one first light guide portion includes one or more first light guide portions extending within the three-dimensional structure.

14. A method of manufacturing a light guide (100) as claimed in claim 1, comprising:
notching into the light guide to create the light separation structure, or
molding the light guide with first light guide portion and the light separation structure integrated therein.
